(19) United States
(12) Patent Application Publication
(10) Pub. No.: US 2008/0303910 A1
(43) Pub. Date: Dec. 11, 2008

(54) Imaging apparatus

(75) Inventor: Toshio Nishida, Yokohama (JP)

Correspondence Address: MCDERMOTT WILL & EMERY LLP, 600 13TH STREET, N.W., WASHINGTON, DC, 20005-3096, US

(73) Assignee: HITACHI, LTD.

(21) Appl. No.: 12/078,830

(22) Filed: Apr. 7, 2008

(30) Foreign Application Priority Data
Jun. 6, 2007 (JP) 2007-149880

(51) Int. Cl. H04N 5/232; H04N 5/222

(52) U.S. Cl. 348/211.11; 348/211.99; 348/E05.042; 348/333.05

(57) ABSTRACT

A camera is provided with a control signal communication unit and a video and audio signal communication unit. A main camera operated by a shooter captures camera driving and operation control information such as panning, tilting, zooming, recording and reproduction conducted by the shooter and transmits the information to a sub camera through the control signal communication unit. The sub camera reflects the received control signal to itself to operate the camera. The sub camera transmits the video which is shot by itself to the main camera through the video and audio signal communication unit. At this point, the main camera receives videos of one or more sub cameras to simultaneously output the videos on a monitor.

### CLAIM OF PRIORITY

The present application claims priority from Japanese application serial no. JP 2007-149880, filed on Jun. 6, 2007, the content of which is hereby incorporated by reference into this application.

### BACKGROUND OF THE INVENTION

1. Field of the Invention

The present invention relates to a camera control system in which a plurality of cameras is controlled by a single camera.

2. Description of the Related Art

There have been proposed various related arts in this technical field.

For example, a technique disclosed in Japanese Patent Application Laid-Open No. 2005-051340 has been known as a related art. According to its abstract, the object is to provide an electronic camera in which a plurality of the electronic cameras is mutually and communicatively controlled to enable it to be used as a remote controller of other electronic cameras. According to its abstract, the problem posed by the above object is solved such that an electronic camera with a communication function is provided with a self control mode and a remote control mode: in the self control mode, the electronic camera sets functions to itself in response to the operation of a user; and in the remote control mode, the electronic camera has a function to transmit setting in response to the operation of a user to other cameras through its communication function. In addition, the problem posed by this object is solved such that an electronic camera with a communication function is provided with a remote control mode in which information transmitted from other electronic cameras is received and various settings such as a camera shooting condition are performed according to the received information.

A technique disclosed in Japanese Patent Application Laid-Open No. 2006-238020 has been known as another related art. The object according to its abstract is to cause a digital camera serving as a host to remotely control the shooting operations of a plurality of other digital cameras. The problem posed by this object is solved such that a host digital camera 1 simultaneously transmits control signals related to the shooting operations of cameras to the slave digital cameras 3 and 4 which establish a link through a radio communication network 5 out of the slave digital cameras 2 to 4, and the slave digital cameras 3 and 4 perform shooting operations in accordance with the control signals simultaneously transmitted from the host digital camera 1.

### SUMMARY OF THE INVENTION

A system handling a plurality of cameras such as a monitoring system and a television conference system causes a single control terminal to control each camera. For example, the monitoring system conducts a monitoring in such a manner that a plurality of cameras is arranged in several positions to output the images of the cameras on a display. At this point, a camera to be optionally selected and changed in shooting direction or a zoom control enables a suspicious figure to be tracked. Each camera such as a fixed-point camera, which is stationary, is operable by a keyboard, a mouse or a dedicated controller. Operation of the camera using these terminals is different from that of an ordinary video camera and requires some experience. This demands a system which a shooter can intuitively operate and by which a plurality of cameras can be controlled.

The above patent document has proposed methods in which a slave camera receives a shooting operation control signal from a host camera to perform the shooting operation, and the images of other cameras are monitored by a remote control. However, these methods put a burden on the shooter because it is impossible to know how each camera captures an object under what circumstances unless the images from each camera are switched and displayed.

Then, it becomes important that other cameras can be operated by a single camera operated by the shooter and user-friendliness is improved for the shooter in camera operation.

The present invention has for its object to operate a plurality of cameras by a single camera and improve the user-friendliness of the camera.

According to one embodiment of the present invention, the above object can be solved by the following configuration, but a solution is not limited to the above configuration.

According to one embodiment of the present invention, an imaging apparatus which shoots a video is characterized in that, in response to the operation of one camera, a control signal is transmitted to one or more of the other cameras to remotely control the other cameras and any one or more video and audio signals is selected from among a plurality of video and audio signals received by the video and audio signal communication unit to output the selected signal on one monitor screen of the display unit.

### BRIEF DESCRIPTION OF THE DRAWINGS

These and other features, objects and advantages of the present invention will become more apparent from the following description when taken in conjunction with the accompanying drawings wherein:

FIG. 1 is a block diagram illustrating a camera control system according to a first embodiment of the present invention;

FIG. 2 is one example in which the camera control system according to the first embodiment of the present invention is applied;

FIGS. 3A, 3B, 3C and 3D are pictures illustrating examples of an image display method to which the camera control system according to the first embodiment of the present invention is applied;

FIGS. 4A and 4B are pictures illustrating examples of the image display method to which the camera control system according to the first embodiment of the present invention is applied;

FIG. 5 is a block diagram illustrating a camera control system according to a second embodiment of the present invention; and

FIG. 6 is a block diagram illustrating a camera control system according to a third embodiment of the present invention.

### DETAILED DESCRIPTION OF THE PREFERRED EMBODIMENTS

One embodiment of the present invention is described below with reference to the drawings.

### First Embodiment

The present embodiment describes an example where the present invention is applied to a video camera.

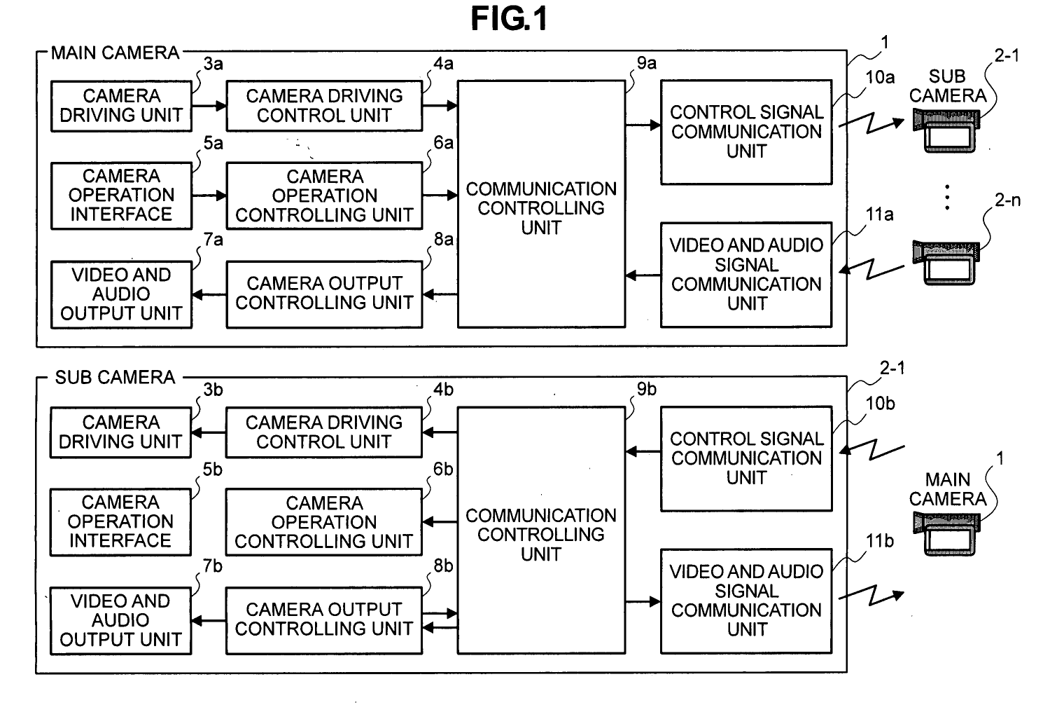

FIG. 1 is a block diagram illustrating a camera control system related to the first embodiment in a method of controlling a plurality of cameras according to the present invention. In FIG. 1, reference numeral 1 denotes a main camera directly operated by a shooter and reference numerals 2-1 to 2-n (n=1, 2, 3, . . . ) denote n sub cameras operated by the shooter through the main camera. The system includes camera driving units 3a and 3b capable of changing at discretion the direction in which the camera is directed, camera driving control units 4a and 4b for controlling the camera driving units 3a and 3b, camera operation interfaces 5a and 5b such as buttons and remote controllers for operating the cameras, camera operation controlling units 6a and 6b for controlling inputs from the camera operation interfaces 5a and 5b, video and audio output units 7a and 7b such as monitors and loudspeakers for outputting video and audio from the cameras, camera output controlling units 8a and 8b for controlling the output to the video and audio output units 7a and 7b, communication controlling units 9a and 9b for conducting communication control between the cameras, control signal communication units 10a and 11b for communicating the control signals for controlling driving and operation between the cameras, and video and audio signal communication units 11a and 11b for transmitting and receiving the video and audio signals between the cameras. The present embodiment describes an example where an angle sensor is mounted on the camera driving unit 3a (universal head) to detect the direction in which the camera is directed. In this case, rotary disks whose rotary shafts in the panning and tilting directions are provided with slits are attached to detect infrared pulses passing through the slits. This enables the rotation angles of their respective shafts to be obtained, allowing detecting the direction in which the camera is directed. The panning and the tilting information may be acquired such that a gyroscopic sensor is mounted on the camera instead of the universal head. Communication between the cameras may be performed by wire or wireless.

A detailed flow of a process to which the present invention is applied is described below.

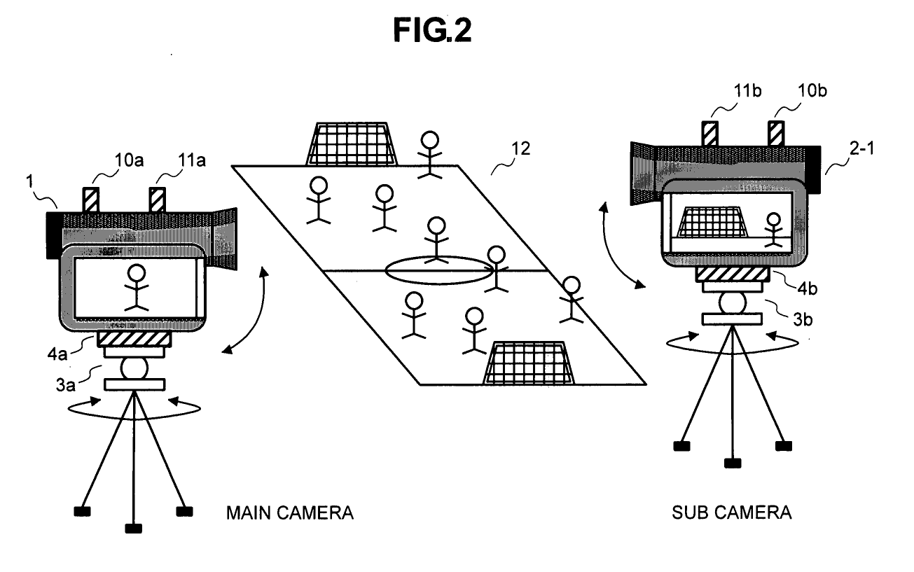

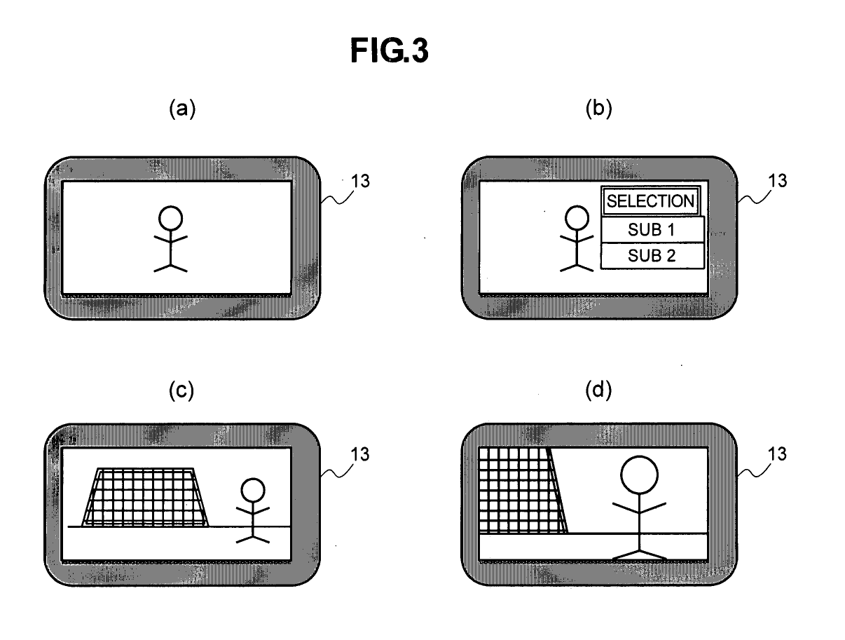

FIG. 2 is one example in which the camera control system according to the first embodiment of the present invention is applied. In FIG. 2, a plurality of cameras shoots an object 12. For the sake of simplicity, only a single camera (sub camera 2-1) is used herein. The sub camera 2-1 is set in advance in any position. The main camera 1 is portable alone and capable of shooting images anywhere. FIGS. 3A, 3B, 3C and 3D are examples of images displayed by a monitor 13 of the main camera 1.

In FIG. 2, the main camera 1 and the sub camera 2-1 shoot different objects from different positions respectively. For example, the sub camera 2-1 shoots a specific place as a fixed-point camera and the main camera 1, on the other hand, shoots a scene at discretion. In this case, the sub camera 2-1 may be set at any position desired and start recording. However, a shooter needs to access the sub camera 2-1 when he or she wants to change the direction in which the sub camera 2-1 is directed or stop the sub camera 2-1, taking a time. Then, the present system controls the sub camera 2-1 through the main camera 1. The shooter selects any desired sub camera through the main camera 1. The shooter produces a table of the sub cameras by the camera output controlling unit 8a to display the table on the monitor 13 of the main camera 1. The above process is illustrated in FIGS. 3A (the screen before a selection menu is displayed) and 3B (the selection menu is displayed). When a desired sub camera is selected, a communication request is issued from the communication controlling unit 9a to the control signal communication unit 10b through the control signal communication unit 10a. The sub camera (sub camera 2-1, herein) which receives the request transmits the output (video and audio signal of the sub camera 2-1) of the camera output controlling unit 8b to the main camera 1, which issues the request, through the communication controlling unit 9b and the video and audio signal communication unit 11b. The main camera 1 receives the output at its video and audio signal communication unit 11b and outputs it from the video and audio output unit 7a through the communication controlling unit 9a and the camera output controlling unit 8a. The above process is illustrated in FIG. 3C. The image from the sub camera 2-1 is displayed on the monitor 13 of the main camera 1. This permits the shooter to view the image shot by the sub camera 2-1 without accessing the sub camera 2-1. In this state, when the shooter performs camera operations of the main camera such as panning, tilting, zooming, starting/stopping recording and reproduction of recorded image, the camera driving control unit 4a and the camera operation controlling unit 6a acquire the amount of driving and operation information to transmit these control signals to the sub camera 2-1 through the control signal communication unit 10a. The sub camera 2-1 which receives the control signals controls the sub camera 2-1 through the camera driving control unit 4b and the camera operation controlling unit 6b to operate the camera as if the sub camera 2-1 were operated. Needless to say, the video and audio signals of the sub camera 2-1 are received by the main camera 1 during this period, so that the video can be watched on the monitor 13 of the main camera 1. That is to say, since the shooter can operate the sub camera 2-1 through the main camera 1 while watching the video shot by the sub camera 2-1, the shooter can operate the sub camera 2-1 as if the shooter were on the scene where the sub camera 2-1 is placed. One example of the above process is illustrated in FIG. 3D, which shows the video subjected to control of panning, tilting and zooming on the sub camera 2-1 through the main camera 1. Incidentally, the video recorded in a recording medium (not shown) provided on the sub camera 2-1 can be viewed through the main camera by the same communication between the cameras.

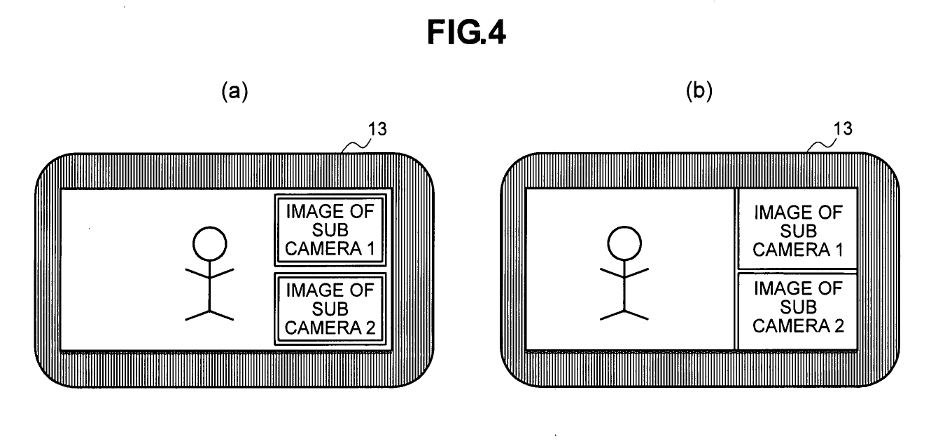

Although the communication control between the main camera 1 and the sub camera 2-1 is described above, the same configuration may be provided for the sub cameras 2-2 to 2-n to enable any camera out of n cameras to be operated as a main camera and the rest of them can be used as sub cameras. Thus, when a plurality of cameras is operated, user-friendliness becomes important. FIGS. 4A and 4B are examples illustrating a method of displaying the video from a plurality of cameras. Assume that any video of the plurality of sub cameras is selected by the communication controlling unit 9a from among the video of the plurality of sub cameras received by the video and audio signal communication unit 11a of the main camera 1 to simultaneously output the videos of the plurality of sub cameras on the monitor 13 of the main camera 1. For example, FIG. 4A illustrates one example of display in the case where the videos of two sub cameras are simultaneously outputted on a background of the video of the main camera 1. FIG. 4B illustrates one example of display in the case where the monitor is divided to three sections to simultaneously output videos of the main camera 1 and the two sub cameras on the monitor. Although the above examples are cited in which the videos of the main camera 1 and two sub cameras are simultaneously outputted, only the videos of the plurality of sub cameras may be simultaneously outputted. The signals from the plurality of sub cameras received by the video and audio signal communication unit 11a are controlled by the communication controlling unit 9a and the camera output controlling unit 8a subjects each camera image to expansion and compression process to produce the aforementioned synthesis and division video. Thus, simultaneously outputting the videos of the plurality of cameras enables confirming how the cameras shoot images. Since the video of each camera can be monitored at any time, the timing of switching a camera to be operated can be adjusted. The video of each camera does not need to be displayed at a full rate. The video of a camera which needs always monitoring, for example, the camera is now shooting, is displayed at a full rate and the videos of the other may be displayed at a lower rate. Although the present embodiment exemplifies the simultaneous output of videos of three cameras, the videos of any number of cameras may be simultaneously outputted. For example, the video of each camera may be captured as a still picture at any timing to collectively thumbnail the videos of all cameras. When the sub camera operated by the main camera 1 is selected, the thumbnail display may be used to display a table of the sub cameras.

According to the present embodiment, a single main camera receives the video of one or more sub cameras to enable their respective videos to be simultaneously outputted on a monitor. This permits simultaneously monitoring the videos of a plurality of cameras to make it effective to support the switching of the camera to be operated, improving user-friendliness.

### Second Embodiment

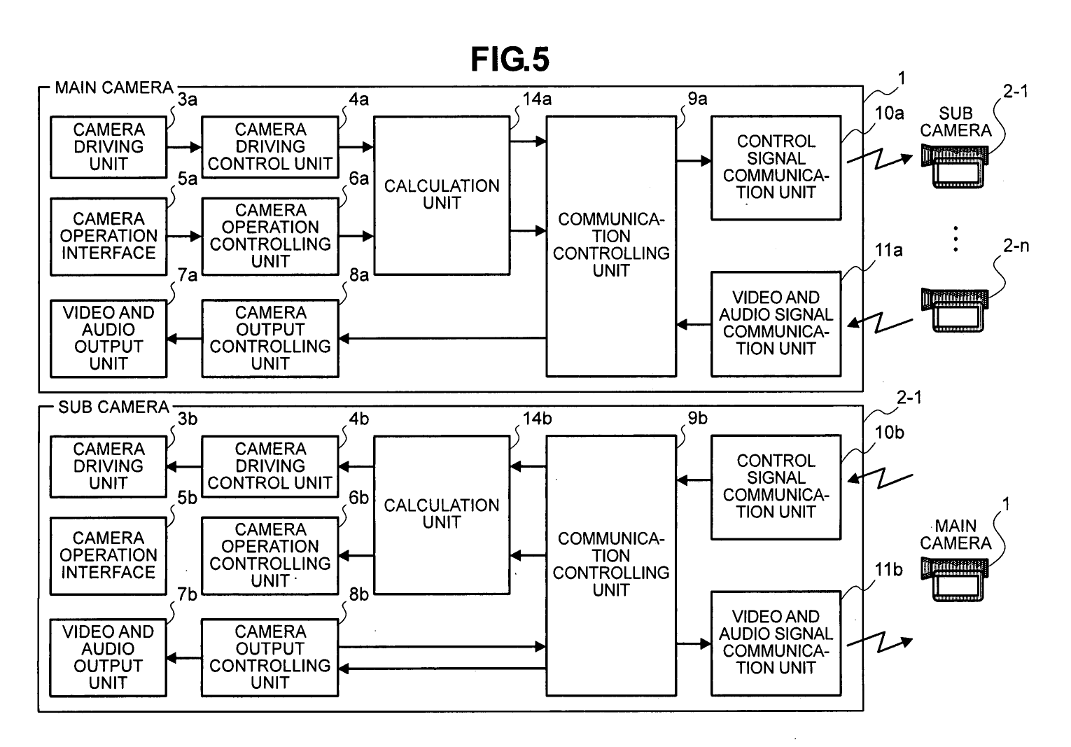

FIG. 5 is a block diagram illustrating a camera control system related to a second embodiment of a method of controlling a plurality of cameras according to the present invention. FIG. 5 adds calculation units 14a and 14b to FIG. 1 which is a block diagram of the first embodiment of the present invention. The first embodiment describes a method of controlling the sub camera 2-1 through the main camera 1 as if the shooter were on the scene where the sub camera 2-1 is placed, thereby conducting operations such as panning, tilting, zooming, starting/stopping recording and reproduction of recorded video. For panning, tilting and zooming out of these operations, the main camera 1 does not always need to be a one-to-one corresponding to the sub camera 2-1. For example, when the main camera 1 is panned by 60 degrees, the sub camera 2-1 to be operated may be set to be panned by 30 degrees or 90 degrees which is different from the angle at which the main camera is panned. This is an effective function if it is set according to a shooting environment. For example, if the periphery of a shooter is too congested to pan the main camera 1, the above function is particularly effective. In this case, if a weighting of 1:3 between the main camera 1 and the sub camera 2-1 is assigned, only slightly moving the main camera 1 enables the sub camera 2-1 to be moved three times as much as the main camera 1. The weighting is assigned by the calculation units 14a and 14b. The calculation units 14a subjects an actual drive amount and operation information obtained from the camera driving control units 4a and the camera operation controlling unit 6a to a weighting process and then the control signal is transmitted to the sub camera 2-1. This realizes a communication control in which a certain weighting is assigned to the main camera 1 and the sub camera 2-1. Incidentally, an actual drive amount and operation information of the main camera 1 are transmitted to the sub camera 2-1 and then the calculation unit 14b of the sub camera 2-1 subjects the actual drive amount and operation information to a weighting process, thereafter the weighting may be reflected to the driving and operation control of the sub camera 2-1 to obtain the same effect.

According to the present embodiment, the operation control in which a certain weighting is assigned to the main camera 1 and the sub camera 2-1 can be realized, so that a flexible control according to an operation environment is enabled.

### Third Embodiment

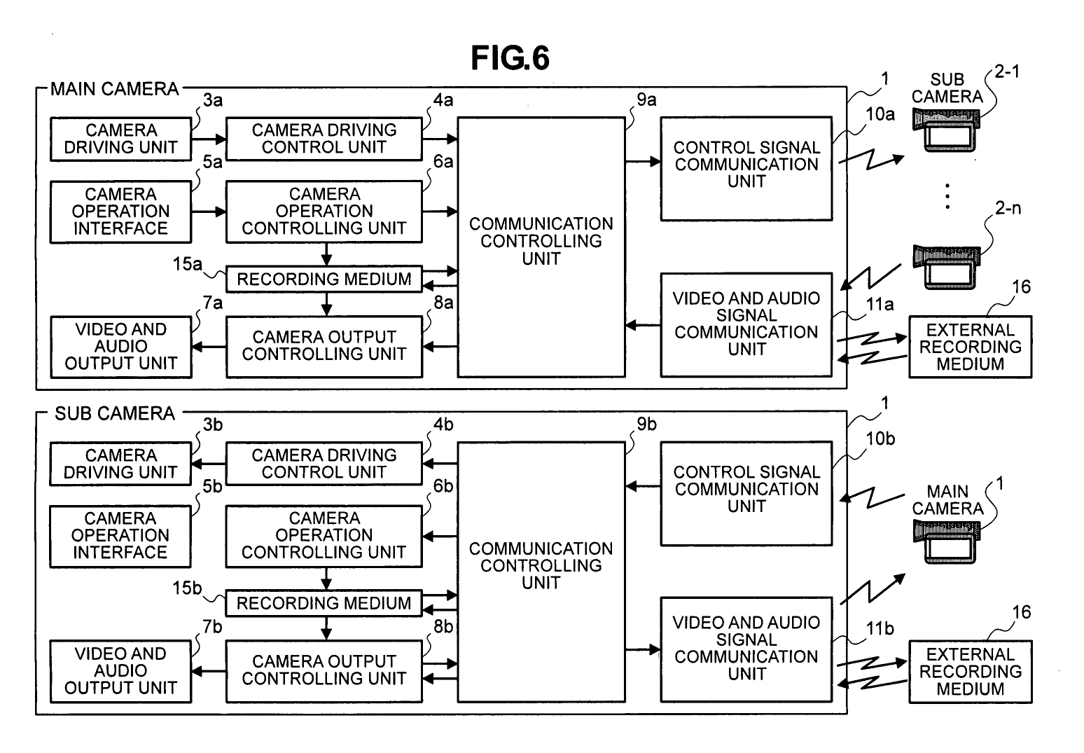

FIG. 6 is a block diagram illustrating a camera control system related to a third embodiment of a method of controlling a plurality of cameras according to the present invention. FIG. 6 adds recording media 15a and 15b in which shot video and audio are recorded and external recording media 16 communicable through the video and audio signal communication units 11a and 11b to FIG. 1 which is a block diagram of the first embodiment of the present invention. When the video and audio signals of the cameras are recorded, they do not always need to be recorded in the camera which is shooting. For example, if the main camera 1 controls the sub camera 2-1 to shoot images, the sub camera 2-1 actually shoots images, so that the video may be recorded in the recording medium 15b mounted on the sub camera 2-1. In this case, the main camera 1 controls the sub camera 2-1 and the camera operation controlling unit 6b performs a recording process to record the video in the recording medium 15b. On the other hand, the shooter performs shooting while operating the main camera 1, so that the video may be recorded in the recording medium 15a mounted on the main camera 1. In this case, the video and audio signals transmitted from the sub camera 2-1 are recorded in the recording medium 15a through the communication controlling unit 9a. If other sub cameras and communicable external recording media 16 are available, video and audio signals may be recorded in a recording medium mounted on other sub cameras or the external recording media 16 through the video and audio signal communication unit 11b. Incidentally, the media in which the signals are recorded may be changed during recording. For example, supposing the main camera 1 controls the sub camera 2-1 to shoot images and record them in the recording medium 15b mounted on the sub camera 2-1 first, if the space capacity of the recording medium 15b runs out during recording, the recording medium 15b can be changed to the recording medium 15a mounted on the main camera 1 or the communicable external recording medium 16, thereby recording can be continued.

As described above, according to the present embodiment, when the video of a camera is recorded, it is enabled to record the video not only in the camera which is actually shooting images but also in a communicable camera or an external recording medium, so that flexible recording control can be realized.

The present invention is not limited to the above embodiments but can be applied to various modifications. For example, the above embodiments are described in detail to clarify the present invention.

The present invention is not always limited to the embodiments with all described components. A part of configuration of an embodiment can be replaced with the configuration of other embodiments and the configuration of other embodiments can be added to the configuration of an embodiment.

The present invention can be applied to a camera system required to control a plurality of cameras.

According to the present invention, a plurality of cameras can be operated by a single camera. User friendliness can be improved in the control of a plurality of cameras.

While we have shown and described several embodiments in accordance with our invention, it should be understood that disclosed embodiments are susceptible to changes and modifications without departing from the scope of the invention. Therefore, we do not intend to be bound by the details shown and described herein but intend to cover all such changes and modifications as fall within the ambit of the appended claims.

What is claimed is:

1. An imaging apparatus which shoots a video comprising:
a display unit which displays a shot video;
a sensor which detects the direction in which the video is shot;
a control signal communication unit which communicates control signals of the sensor and a camera operation between cameras; and
a video and audio signal communication unit which communicates video and audio signals between the cameras; wherein
in response to the operation of one camera, a control signal is transmitted to one or more of the other cameras to remotely control the other cameras and
any one or more video and audio signals is selected from among a plurality of video and audio signals received by the video and audio signal communication unit to output the selected signal on one monitor screen of the display unit.

2. The imaging apparatus according to claim 1, wherein
videos different in frame rate are output on one monitor screen of the display unit.

3. The imaging apparatus according to claim 1, wherein
a remote control is performed with weighting assigned.

4. The imaging apparatus according to claim 1, furthering comprising a function to record the video and audio signal of the camera in a communicable camera or an external recording medium through the video and audio signal communication unit.

5. The imaging apparatus according to claim 4, furthering comprising a function to switch a recording destination during recording.
